(19) United States
(12) Patent Application Publication
(10) Pub. No.: US 2026/0369876 A1
(43) Pub. Date: Nov. 19, 2026

(54) RADIO FREQUENCY FEED NETWORKS HAVING SELECTIVE CAPACITIVE COUPLING, AND RELATED METHODS OF OPERATING A BASE STATION ANTENNA

(71) Applicant: Outdoor Wireless Networks LLC, Richardson, TX (US)

(72) Inventors: Haiyan Chen, Suzhou (CN); Hangsheng Wen, Suzhou (CN); Maosheng Liu, Suzhou (CN); Honghui Li, Suzhou (CN); Ligang Wu, Suzhou (CN)

(21) Appl. No.: 19/124,407

(22) PCT Filed: Nov. 17, 2023
(86) PCT No.: PCT/US2023/080292

§ 371 Date: Apr. 25, 2025

Related U.S. Application Data
(60) Provisional application No. 63/384,146, filed on Nov. 17, 2022.

(51) Int. Cl. H01Q 1/50; H01Q 1/24

(52) U.S. Cl. CPC H01Q 1/50; H01Q 1/246

(57) ABSTRACT

Radio frequency (RF) feed networks are provided. An RF feed network includes a plurality of RF paths. The RF paths are selectively coupled between arrays of radiating elements of a base station antenna and an input of the RF feed network. Related methods of operating a base station antenna are also provided.

### FIELD

The present disclosure relates to communications systems and, in particular, to radio frequency (“RF”) feed networks that are usable, for example, with base station antennas.

### BACKGROUND

Cellular communications systems are well known in the art. In a cellular communications system, a geographic area is divided into a series of regions or “cells” that are served by respective base stations. Each base station may include one or more base station antennas that are configured to provide two-way RF communications with subscribers that are within the cell served by the base station. In many cases, each base station is divided into “sectors.” In one common configuration, a hexagonally-shaped cell is divided into three 120° sectors in the azimuth plane, and each sector is served by one or more base station antennas that generate outwardly-directed radiation patterns. For example, a base station antenna may generate an omnidirectional antenna pattern in the azimuth plane, meaning that the base station antenna may provide coverage extending through a full 360° circle in the azimuth plane.

Example base station antennas are discussed in International Publication No. WO 2017/165512 to Bisiules, U.S. patent application Ser. No. 15/921,694 to Bisiules et al., and U.S. Patent Application No. 63/024,846 to Hamdy et al., the disclosures of which are hereby incorporated herein by reference in their entireties. Base station antennas typically include one or more linear arrays or two-dimensional arrays of radiating elements, such as dipole, or crossed-dipole, radiating elements that act as individual antenna elements. An RF feed network may be used to pass RF signals between the arrays and one or more radios.

### SUMMARY

Pursuant to some embodiments of the present invention, a base station antenna is provided that may include a plurality of arrays of radiating elements. Moreover, the base station antenna may include an RF feed network that has a plurality of stationary RF transmission lines that are selectively coupled between the arrays and an input of the RF feed network by one or more movable RF transmission lines.

In some embodiments, the one or more movable RF transmission lines may include a plurality of metal traces that are on a plurality of independently-movable printed circuit boards (“PCBs”), respectively. The stationary RF transmission lines may be selectively coupled between the arrays and the input of the RF feed network by selective capacitive coupling between the stationary RF transmission lines and the independently-movable PCBs, respectively.

According to some embodiments, the independently-movable PCBs may be configured to move linearly. In other embodiments, the independently-movable PCBs may be configured to move rotationally.

In some embodiments, the one or more movable RF transmission lines may include a plurality of metal traces that share a movable PCB and selectively couple the stationary RF transmission lines, respectively, between the arrays and the input of the RF feed network.

According to some embodiments, a first of the metal traces of the movable PCB may be configured to couple a first of the stationary RF transmission lines between the arrays and the input of the RF feed network, while a second and a third of the stationary RF transmission lines are not coupled between the arrays and the input of the RF feed network.

In some embodiments, the movable PCB may be further configured to move to decouple the first of the stationary RF transmission lines from between the arrays and the input of the RF feed network and to couple, via a second of the metal traces of the movable PCB, the second of the stationary RF transmission lines between the arrays and the input of the RF feed network.

According to some embodiments, the movable PCB may be further configured to move to decouple the second of the stationary RF transmission lines from between the arrays and the input of the RF feed network and to couple, via a third of the metal traces of the movable PCB, the third of the stationary RF transmission lines between the arrays and the input of the RF feed network.

In some embodiments, the movable PCB may be configured to move linearly. In other embodiments, the movable PCB may be configured to move rotationally.

According to some embodiments, the one or more movable RF transmission lines may include a single metal trace that is on a movable PCB and is selectively capacitively coupled to any of the stationary RF transmission lines.

In some embodiments, the movable PCB may be configured to capacitively couple the single metal trace to a first of the stationary RF transmission lines.

According to some embodiments, the movable PCB may be further configured to move to capacitively decouple the single metal trace from the first of the stationary RF transmission lines and to capacitively couple the single metal trace to a second of the stationary RF transmission lines.

In some embodiments, the movable PCB may be further configured to move to capacitively decouple the single metal trace from the second of the stationary RF transmission lines and to capacitively couple the single metal trace to a third of the stationary RF transmission lines.

According to some embodiments, the movable PCB may be configured to move linearly. In other embodiments, the movable PCB may be configured to move rotationally.

In some embodiments, the base station antenna may include a triangular reflector that has a plurality of faces that face in different directions, respectively. The arrays of radiating elements may be on the respective faces of the reflector. The stationary RF transmission lines may include three impedance-matching paths.

According to some embodiments, the stationary RF transmission lines may include respective impedance-matching paths. The RF feed network may include: a plurality of stationary array-selection paths that are coupled between the arrays and the impedance-matching paths; and a plurality of movable PCBs having respective metal traces thereon that are configured to be selectively capacitively coupled to respective stubs that are coupled to the stationary array-selection paths, respectively.

In some embodiments, the stationary RF transmission lines may be respective impedance-matching paths, and the RF feed network may include: a plurality of stationary array-selection paths that are coupled between the arrays and the impedance-matching paths; and a movable PCB including a plurality of metal traces that share the movable PCB and are configured to be selectively capacitively coupled to any of a plurality of stubs that are coupled to the stationary array-selection paths, respectively.

According to some embodiments, the stationary RF transmission lines may be respective impedance-matching paths that each include a first portion and a second portion that is spaced apart from the first portion. Each of the one or more movable RF transmission lines may be configured to be capacitively coupled to the first and second portions of a respective one of the impedance-matching paths.

A method of operating a base station antenna, according to some embodiments, may include selectively capacitively coupling a first of a plurality of stationary RF transmission lines of an RF feed network of the base station antenna to a movable RF transmission line of the RF feed network by moving the movable RF transmission line. The stationary RF transmission lines may be coupled between an input of the RF feed network and a plurality of arrays of radiating elements of the base station antenna.

In some embodiments, the movable RF transmission line may include a metal trace on a movable PCB. Moving the movable RF transmission line may include linearly or rotationally moving the movable PCB.

According to some embodiments, the movable PCB may be a first of a plurality of independently-movable PCBs that are selectively capacitively coupled to the stationary RF transmission lines, respectively.

In some embodiments, the method may include selectively capacitively coupling a second of the stationary RF transmission lines to the movable RF transmission line by moving the movable RF transmission line away from the first of the stationary RF transmission lines and toward the second of the stationary RF transmission lines.

According to some embodiments, the method may include selectively capacitively coupling a third of the stationary RF transmission lines to the movable RF transmission line by moving the movable RF transmission line away from the second of the stationary RF transmission lines and toward the third of the stationary RF transmission lines.

In some embodiments, the movable RF transmission line may include a first of a plurality of metal traces that share a movable PCB. The method may include selectively capacitively coupling a second of the stationary RF transmission lines to a second of the metal traces on the movable PCB by moving the movable PCB. Moreover, the method may include selectively capacitively coupling a third of the stationary RF transmission lines to a third of the metal traces on the movable PCB by moving the movable PCB.

According to some embodiments, the stationary RF transmission lines may be respective impedance-matching paths. The RF feed network may include: a plurality of stationary array-selection paths that are coupled between the arrays and the impedance-matching paths; and a movable PCB including a plurality of metal traces thereon that share the movable PCB. Moreover, the method may include selectively capacitively coupling any of the metal traces of the movable PCB to any of a plurality of stubs that are coupled to the stationary array-selection paths, respectively, by moving the movable PCB.

A base station antenna, according to some embodiments, may include a plurality of arrays of radiating elements and an RF feed network that has a plurality of stationary impedance-matching paths that are selectively coupled between the arrays and an input of the RF feed network by a plurality of movable RF transmission lines, respectively.

In some embodiments, the movable RF transmission lines may include a plurality of metal traces that are on a plurality of independently-movable PCBs, respectively.

According to some embodiments, the movable RF transmission lines may include a plurality of metal traces that share a movable PCB.

A base station antenna, according to some embodiments, may include: a plurality of arrays of radiating elements; and an RF feed network that has a plurality of stationary impedance-matching paths that are selectively coupled between the arrays and an input of the RF feed network by a single movable RF transmission line.

In some embodiments, the single movable RF transmission line may include a single metal trace that is on a movable PCB and is selectively capacitively coupled to any of the stationary RF transmission lines.

### BRIEF DESCRIPTION OF THE DRAWINGS

FIG. 1A is a top view of a base station antenna, according to embodiments of the present invention.

FIG. 1B is a schematic block diagram of ports of the base station antenna of FIG. 1A electrically connected to ports of a radio.

FIG. 2A is an example schematic block diagram of the feed network of FIG. 1B, according to some embodiments of the present invention.

FIG. 2B is a schematic block diagram of a PCB comprising a first of the paths of the impedance-matching portion of FIG. 2A.

FIG. 2C is another example schematic block diagram of the feed network of FIG. 1B, according to further embodiments of the present invention.

FIG. 3A is an example front view of the feed network of FIG. 2A, with switching elements omitted from view.

FIG. 3B is a front view of the switching elements that are omitted from view in FIG. 3A.

FIG. 3C is an enlarged view of a first of the switching elements of FIG. 3B that comprises a conductive trace on a respective movable PCB, according to some embodiments of the present invention.

FIG. 3D is an enlarged view of switching elements of FIG. 3B that comprise respective conductive traces that share a movable PCB, according to other embodiments of the present invention.

FIG. 3E is a schematic rear view of a movable PCB that is configured to move rotationally, according to further embodiments of the present invention.

FIG. 3F is an example front view of the feed network of FIG. 2C.

FIG. 3G is an enlarged view of the switch of the impedance-matching portion of FIG. 3F.

FIG. 3H is a schematic block diagram of a movable PCB that is configured to select any of seven states of the array-selection portion of the feed network of FIG. 1B, according to other embodiments of the present invention.

FIG. 3I is a schematic block diagram showing seven different positions of the movable PCB of FIG. 3H.

FIGS. 4A-4G are flowcharts illustrating operations of switching between the RF paths shown in FIGS. 2A-2C.

### DETAILED DESCRIPTION

Pursuant to embodiments of the present invention, RF feed networks are provided that can efficiently direct RF energy from a radio to all sectors, or to one or more selected (but not all) sectors, of a multi-sector base station antenna. In conventional multi-sector antennas, the use of fewer than all sectors (i.e., directing RF energy to at least one sector while refraining from directing RF energy to at least one other sector) can result in significant power-division losses. For example, in most conventional implementations, if the RF energy is only directed to two of the sectors, then one third of the RF energy is lost, and if the RF energy is directed to a single sector, then two-thirds of the RF energy is lost. The selection of different sectors, or combinations thereof, in conventional antennas may also require a large number of switching elements, which can complicate feed network circuitry/operations, increase costs, and increase insertion losses. Moreover, conventional switching elements, such as PIN diodes, may be expensive and/or unable to handle high power RF signals without creating passive intermodulation (“PIM”) distortion.

According to embodiments of the present invention, RF feed networks are provided that can direct all of the RF energy to a selected sector or combination of sectors and that also exhibit reduced PIM distortion relative to conventional base station antennas. The antennas according to embodiments of the present invention may use a switching element (e.g., a wiper-type switch) that comprises a movable RF transmission line that is selectively capacitively coupled to a selected one of a plurality of stationary RF transmission lines, rather than using switching elements that physically contact the stationary transmission lines, while also being highly controllable by allowing for selection of any permutation of sectors. For example, the movable transmission line may be implemented by using a conductive trace on a movable PCB, and may therefore provide a low-cost solution that is relatively easy to achieve. In some embodiments, the movable PCB may be linearly movable, which may facilitate use of a small movable PCB in a narrow space. Moreover, the movable transmission line may facilitate high-power RF performance of a base station antenna.

Example embodiments of the present invention will be described in greater detail with reference to the attached figures.

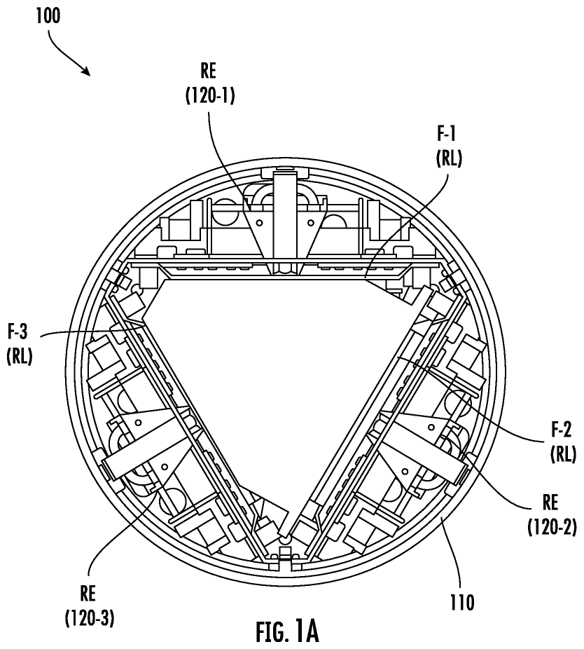

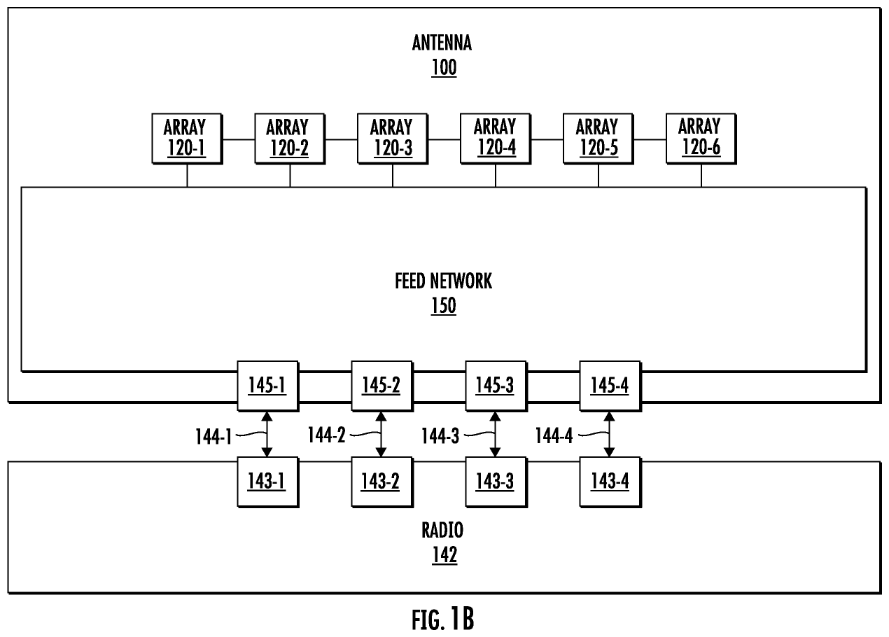

FIG. 1A is a top view of a multi-sector base station antenna 100, according to embodiments of the present invention. The antenna 100 may be, for example, a cellular base station antenna at a macrocell base station or at a small cell base station. The antenna 100 includes a radome 110. In some embodiments, the antenna 100 further includes a top end cap and/or a bottom end cap. For simplicity of illustration, the top end cap is omitted from view in FIG. 1A. The bottom end cap may include a plurality of RF connectors 145 (FIG. 1B) mounted therein. The connectors 145, which may also be referred to herein as “ports,” are not limited, however, to being located on the bottom end cap. The antenna 100 is typically mounted in a vertical configuration (i.e., the long side of the antenna 100 extends along a vertical axis with respect to Earth).

The antenna 100 includes a reflector assembly RL having a triangular cross-section, and six arrays 120-1 through 120-6 of radiating elements RE mounted on three faces F-1 through F-3, respectively, of the reflector assembly RL. Two arrays 120 are vertically stacked on each face, with arrays 120-1 and 120-2 vertically stacked on face F-1, arrays 120-3 and 120-4 vertically stacked on face F-2, and arrays 120-5 and 120-6 vertically stacked on face F-3. The radiating elements RE are mounted to extend outwardly from the faces F and such that each array 120 is oriented generally vertically with respect to the horizon when the antenna 100 is mounted for use. Each face F may act as a reflector and as a ground plane for the radiating elements RE mounted thereon.

The radiating elements RE may have various shapes and/or structures. For example, the radiating elements RE may be PCB-based or sheet-metal-based radiating elements that may be implemented with various shapes and/or feeding techniques. In some embodiments, the radiating elements RE may be patch radiating elements or crossed-dipole radiating elements.

Though the reflector assembly RL is shown in FIG. 1A as having three faces F-1 through F-3, the reflector assembly RL may, in other embodiments, have additional faces F, such as a total of four faces F that have respective arrays 120 mounted thereon. Accordingly, the antenna 100 may be implemented as a four-sector antenna rather than the tri-sector antenna that is shown in FIG. 1A. The reflector assembly RL may thus have a non-triangular cross-section, such as a rectangular cross-section. The reflector assembly RL may have other numbers of faces F and/or other numbers of arrays 120 mounted on the faces F. For example, in still other embodiments, the reflector assembly RL may have six faces F (i.e., a hexagonal horizontal cross-section) with six or twelve linear arrays 120 or have eight faces F (i.e., an octagonal horizontal cross-section) with eight or sixteen linear arrays 120.

FIG. 1B is a schematic block diagram of the base station antenna 100 showing its connections to respective ports 143 of a radio 142. For example, the radio 142 may be a cellular base station radio, such as a remote radio head, and the antenna 100 and the radio 142 may be located at (e.g., may be components of) a cellular base station. In some embodiments, the radio 142 may be mounted below the antenna 100. As shown in FIG. 1B, ports 145-1 through 145-4 of the antenna 100 are electrically connected to ports 143-1 through 143-4, respectively, of the radio 142 by respective RF transmission lines 144-1 through 144-4, such as coaxial cables. The ports 145-1 through 145-4 of the antenna 100 are electrically coupled to six arrays of radiating elements 120-1 through 120-6 through an RF feed network 150.

In some embodiments, the radio 142 may be a four-port radio configured to operate using a time division duplex (“TDD”) communications scheme. The RF feed network 150 is coupled between the six arrays 120-1 through 120-6 and the radio 142. For example, the arrays 120 may be coupled to respective RF transmission paths (e.g., including one or more RF transmission lines) of the feed network 150. The RF feed network 150 may be configured to direct substantially all of the RF energy output by first and second radio ports 145-1, 145-2 (one for each of two polarizations) to a selected one or more of the three arrays 120-1 through 120-3 during selected time slots in a frame structure of the TDD communications scheme. For example, during a given time slot, RF feed network 150 may direct substantially all of the RF energy output by the first radio port 145-1 to array 120-1, to array 120-2, to array 120-3, to arrays 120-1 and 120-2, to arrays 120-2 and 120-3, to arrays 120-1 and 120-3, or to all three of arrays 120-1 through 120-3, depending upon the desired antenna pattern for the time slot. The RF feed network 150 is likewise configured to direct substantially all of the RF energy output by the second radio port 145-2 to array 120-1, to array 120-2, to array 120-3, to arrays 120-1 and 120-2, to arrays 120-2 and 120-3, to arrays 120-1 and 120-3, or to all three of arrays 120-1 through 120-3, depending upon the desired antenna pattern for the time slot. Similarly, the RF feed network 150 is configured to direct substantially all of the RF energy output by third and fourth radio ports 145-3, 145-4 (one for each of two polarizations) to a selected one or more of the three arrays 120-4 through 120-6 during selected time slots in a frame structure of the TDD communications scheme. According to some embodiments, the ports 145-1 and 145-3 may be first-polarization ports, meaning that these ports are selectively coupled to the first-polarization radiators of the radiating elements RE in arrays 120-1 to 120-3 (for port 145-1) and arrays 120-4 to 120-6 (for port 145-3). In such embodiments, the ports 145-2 and 145-4 may be second-polarization ports, meaning that these ports are selectively coupled to the second-polarization radiators of the radiating elements RE in arrays 120-1 to 120-3 (for port 145-2) and arrays 120-4 to 120-6 (for port 145-4).

As discussed above, in some embodiments, the six arrays 120-1 through 120-6 may be arranged as three pairs of vertically-stacked arrays of radiating elements RE. In other embodiments, the six arrays 120-1 through 120-6 may be arranged so that two arrays 120 are provided side-by-side on each of the three faces F-1 through F-3 of the reflector assembly RL. It will also be appreciated that more or fewer than six arrays 120 may be included in the antenna 100. For example, a total of three arrays 120 could be provided in other embodiments, with a single array 120 per face F of the reflector assembly RL. Such embodiments would typically be coupled to a two-port radio 142. In other embodiments, more than two arrays 120 could be provided per face F of the reflector assembly RL, and the radio 142 could include more than four ports 143.

Radiating elements RE of the six arrays 120-1 through 120-6 may transmit and/or receive RF signals in one or more frequency bands, such as one or more bands comprising frequencies between 3.3 gigahertz (“GHz”) and 4.2 GHz. For example, the radiating elements RE may, in some embodiments, transmit and/or receive RF signals at about 3.5 (or about 3.85) GHz in a TDD communications scheme.

The arrays 120 may each include a plurality of radiating elements RE that are spaced apart from each other in a vertical direction so that each array 120 extends in the vertical direction. As discussed above, two arrays 120 may be vertically-stacked on each face F of the reflector assembly RL, so that together each pair of vertically-stacked arrays 120 extend from a lower portion of an antenna assembly of antenna 100 to an upper portion of the antenna assembly. The vertical direction may be, or may be parallel with, a longitudinal axis that is perpendicular to the horizon. As used herein, the term “vertical” does not necessarily require that something is exactly vertical (e.g., the antenna 100 may have a small mechanical down-tilt). The number of radiating elements RE in an array 120 can be any quantity from one to twenty or more. In some embodiments, the arrays 120 may each have the same number (e.g., eight) of radiating elements RE.

According to some embodiments, the radiating elements RE are dual-polarized and each array 120 is coupled to a single port 145 per polarization. For example, the arrays 120-1, 120-2, and 120-3 may each be coupled to the first-polarization port 145-1 and the second-polarization port 145-2. The arrays 120-4, 120-5, and 120-6 may each be coupled to the first-polarization port 145-3 and the second-polarization port 145-4. Accordingly, each array 120 is coupled to two of the ports 145-1 through 145-4.

Moreover, the antenna 100 may include phase shifters that are used to electronically adjust the downtilt angles of radiation patterns generated by the arrays 120. The phase shifters may be located at any appropriate location along the RF transmission paths that extend between the ports 145 and the arrays 120. Accordingly, though omitted from view in FIG. 1B for simplicity of illustration, the feed network 150 may include phase shifters.

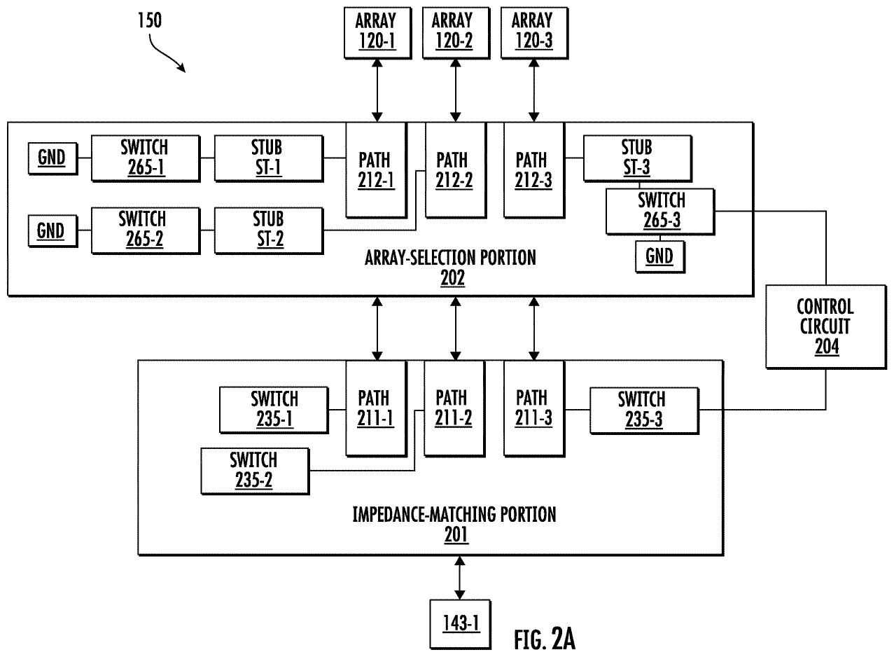

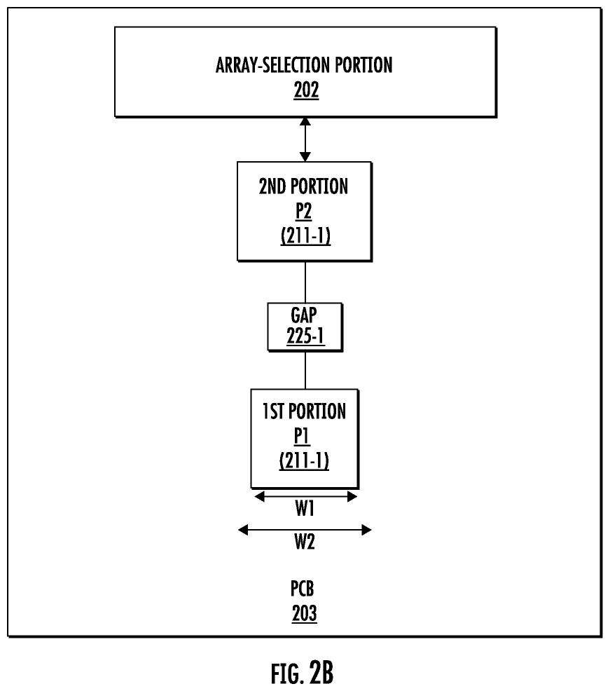

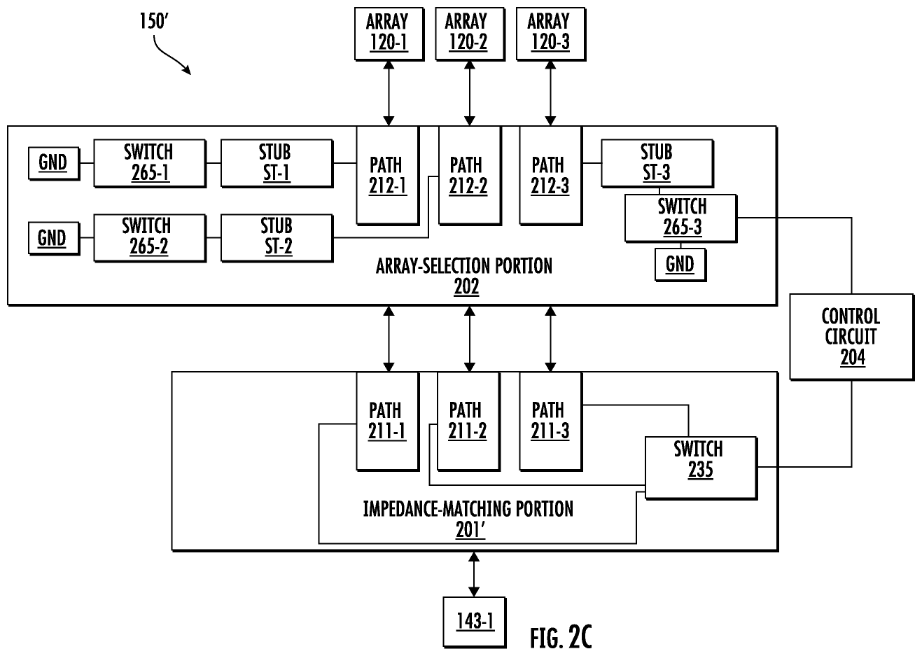

FIG. 2A is an example schematic block diagram of one portion of the feed network 150 of FIG. 1B that shows the connections between a first of the radio ports 143-1 and the three arrays 120-1 through 120-3 that are fed by the first radio port 143-1. The other three portions of the feed network 150 that connect the second radio port 143-2 to arrays 120-1 through 120-3 and that connect the third and fourth radio ports 143-3, 143-4 to arrays 120-4 through 120-6 may be identical/analogous to the first portion of the feed network shown in FIG. 2A. As shown in FIG. 2A, each portion of the feed network 150 includes an impedance-matching portion 201 and an array-selection portion 202. The array-selection portion 202 is coupled between the impedance-matching portion 201 and the three arrays 120-1 through 120-3. Moreover, the impedance-matching portion 201 is coupled between the array-selection portion 202 and the first port 143-1 of the radio 142. In some embodiments, a first port 145-1 (FIG. 1B) of the base station antenna 100 (FIG. 1B) may be coupled between the first port 143-1 and the impedance-matching portion 201.

For simplicity of illustration, FIG. 2A shows RF paths (of the impedance-matching portion 201 and the array-selection portion 202) between the three arrays 120-1 through 120-3 and the first port 143-1. Analogous RF paths may be between the second radio port 143-2 and the three arrays 120-1 through 120-3. Moreover, analogous RF paths may be between the third and fourth radio ports 143-3, 143-4 and the arrays 120-4 through 120-6.

As shown in FIG. 2A, the impedance-matching portion 201 includes three RF paths 211-1 through 211-3 (also referred to herein as “impedance-matching paths”) that are coupled between the first port 143-1 and the array-selection portion 202. Each path 211 may be selectively connected or disconnected between the array-selection portion 202 and the first port 143-1 by a respective switching element 235. Accordingly, three switching elements 235-1 through 235-3 may selectively direct RF signals between the first port 143-1 and the array-selection portion 202 via a selected one of the three RF paths 211-1 through 211-3, respectively.

The array-selection portion 202 includes three RF paths 212-1 through 212-3 that are coupled between the three arrays 120-1 through 120-3, respectively, and the impedance-matching portion 201. Each path 212 is coupled to a respective RF transmission line that is switchably coupled to electrical ground GND. For example, FIG. 2A illustrates three RF transmission lines that are implemented as three stubs ST-1 through ST-3, respectively, that are switchably coupled to ground GND by three switching elements 265-1 through 265-3, respectively. According to some embodiments, each of the stubs ST may be a λ/4 stub, where λ is the wavelength corresponding to the center frequency of the operating frequency band of the arrays 120.

In some embodiments, the antenna 100 may include a control circuit 204 that is configured to control the three switching elements 235 of the impedance-matching portion 201 and the three switching elements 265 of the array-selection portion 202. In other embodiments, the switching elements 235 may be controlled by a control circuit 204 different from that which controls the switching elements 265. When a switching element 265 short-circuits the stub ST to ground GND, the stub ST becomes transparent to RF energy in the operating frequency band of the arrays 120 and such RF energy can thus flow though the path 212 that is coupled to the stub ST. On the other hand, when the switching element 265 disconnects the stub ST from ground GND, the stub ST acts to reflect RF energy in the operating frequency band of the arrays 120 from proceeding through the path 212 and redirects it to one or more other paths 212, as will be explained in further detail below.

For simplicity of illustration, the control circuit 204 is shown in FIG. 2A as being coupled to the third switching element 235-3 of the impedance-matching portion 201 and the third switching element 265-3 of the array-selection portion 202, without showing connections between the control circuit 204 and the first and second switching elements 235-1, 235-2 of the impedance-matching portion 201 or between the control circuit 204 and the first and second switching elements 265-1, 265-2 of the array-selection portion 202. In some embodiments, however, the control circuit 204 may be coupled to the three switching elements 235-1 through 235-3 and/or to the three switching elements 265-1 through 265-3.

FIG. 2B is a schematic block diagram of a printed circuit board (“PCB”) 203 comprising a first path 211-1 of the impedance-matching portion 201 of FIG. 2A. The path 211-1 includes a first portion P1 and a second portion P2 that is coupled between the array-selection portion 202 and the first portion P1. In some embodiments, the first and second portions P1, P2 are separated from each other by a first gap 225-1.

Moreover, the first and second portions P1, P2 may comprise metal (e.g., copper) traces having different first and second line widths W1, W2, respectively, on the PCB 203. For example, the second line width W2 may be wider than the first line width W1, and thus may provide the second portion P2 with a lower impedance than the first portion P1. As an example, the first and second portions P1, P2 may be first and second RF transmission lines, respectively, that have impedances of 50 ohms and 28.8 ohms, respectively. Techniques other than adjusting the line widths may alternatively be used to adjust the impedances of the first and second portions, as is known in the art.

For simplicity of illustration, the second and third paths 211-2, 211-3 of the impedance-matching portion 201 are omitted from view in FIG. 2B. Like the first path 211-1, however, the second and third paths 211-2, 211-3 may each have first and second portions P1, P2 (e.g., first and second RF transmission lines) on the PCB 203 that are separated from each other by a gap 225. Moreover, though each gap 225 may be selectively bridged by a respective switching element 235 (FIG. 2A), the switching elements 235 are omitted from view in FIG. 2B for simplicity of illustration.

According to some embodiments, ground GND (FIG. 2A) may be provided by a ground plane on the rear surface of the PCB 203. The ground plane may comprise, for example, copper. Moreover, the array-selection portion 202 may share the front surface of the PCB 203 with the impedance-matching portion 201.

FIG. 2C is another example schematic block diagram of the feed network of FIG. 1B, according to further embodiments of the present invention. As shown in FIG. 2C, a feed network 150′ may be different from the feed network 150 of FIG. 2A, in that a single switching element 235 may be selectively coupled to any of the three paths 211-1 through 211-3 of an impedance-matching portion 201′. The three paths 211-1 through 211-3 of the impedance-matching portion 201′ may thus be controlled by the same switching element 235 rather than the three switching elements 235-1 through 235-3, respectively, that are shown in FIG. 2A with respect to the impedance-matching portion 201.

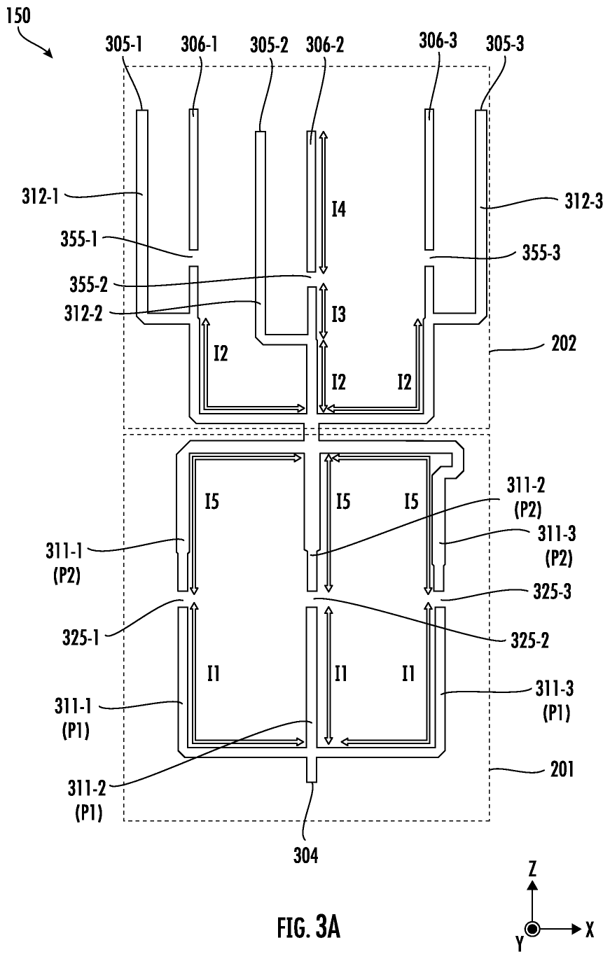

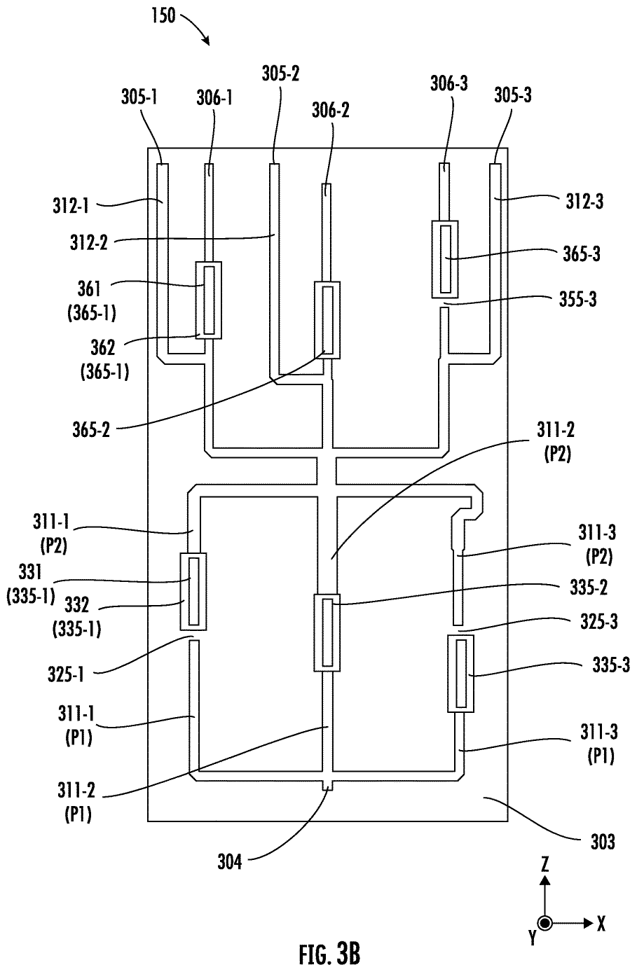

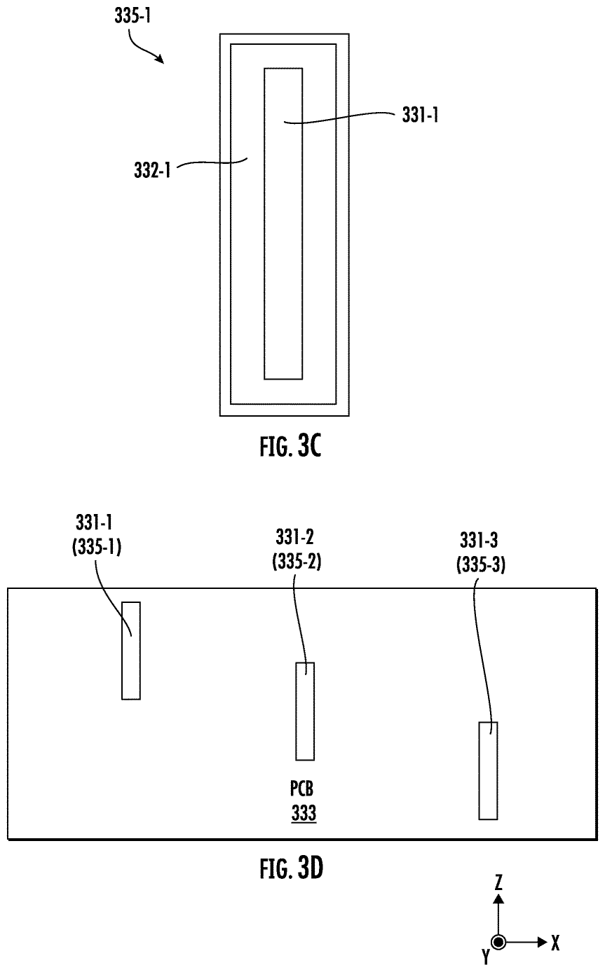

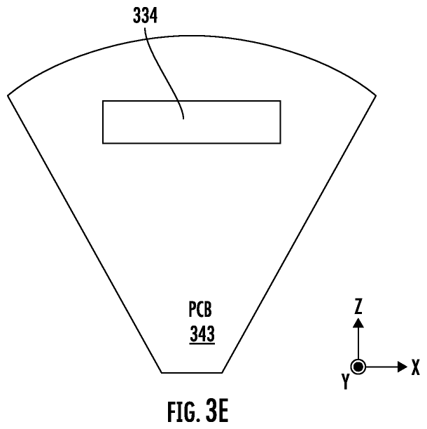

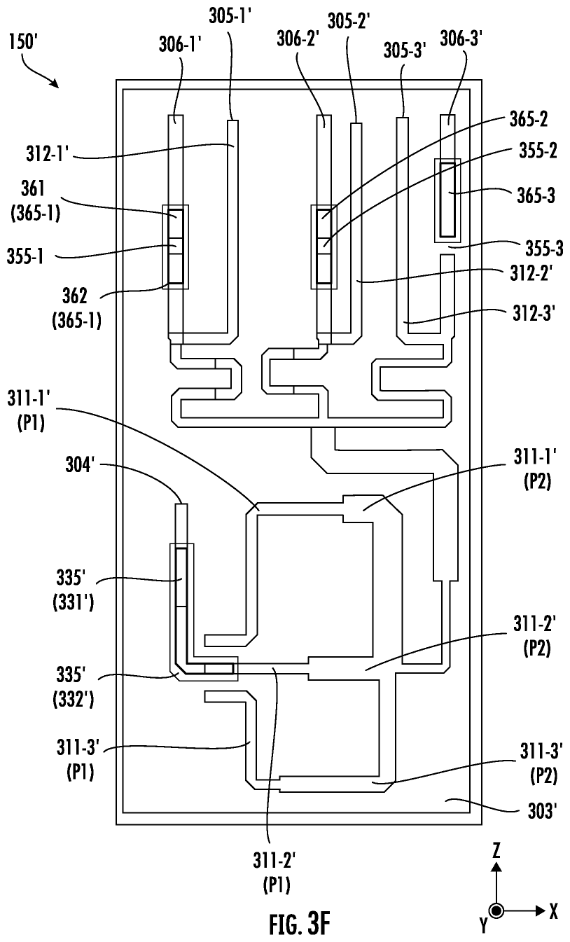

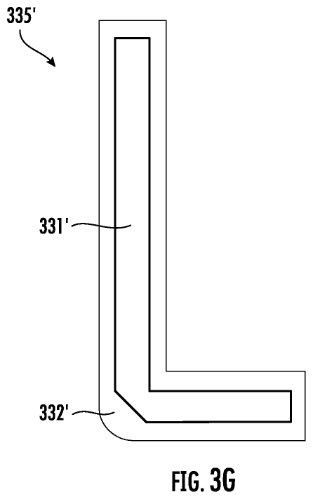

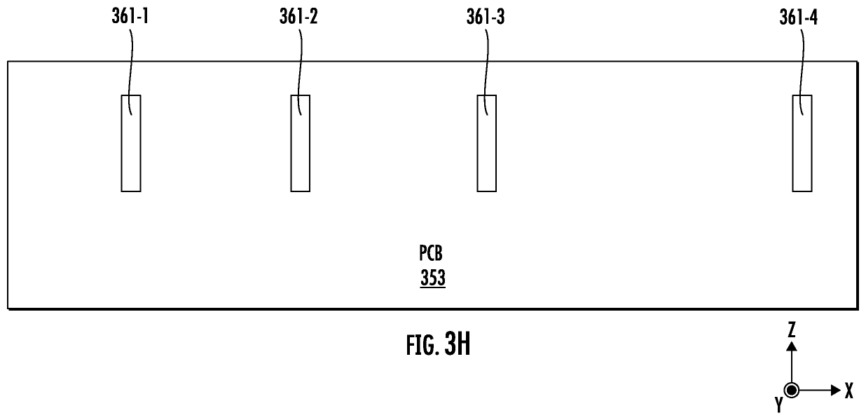

FIG. 3A is an example front view of the feed network 150 of FIG. 2A. For simplicity of illustration, switching elements 335, 365 (FIG. 3B) and a PCB 303 (FIG. 3B) having the switching elements 335, 365 thereon are omitted from view in FIG. 3A. As shown in FIG. 3A, the feed network 150 may comprise the impedance-matching portion 201 and the array-selection portion 202, both of which can be implemented on a stationary PCB (e.g., the PCB 303). The impedance-matching portion 201 may be coupled between the array-selection portion 202 and an RF input node 304 of the feed network 150. Moreover, the impedance-matching portion 201 may comprise a plurality of impedance-matching paths 311 that may be formed in the stationary PCB, and the array-selection portion 202 may comprise a plurality of array-selection paths 312 that may also be formed in the stationary PCB. The paths 311 may be examples of the RF paths 211 that are shown in FIG. 2A, and the paths 312 may be examples of the RF paths 212 that are shown in FIG. 2A.

In some embodiments, the paths 311 may comprise three impedance-matching paths 311-1 through 311-3 that may that are coupled between the RF input node 304 and the array-selection portion 202. For example, the three impedance-matching paths 311-1 through 311-3 may each comprise a first portion P1 and a second portion P2, where the first portion is coupled between the RF input node 304 and the second portion P2. Moreover, the RF input node 304 may be coupled between the three impedance-matching paths 311-1 through 311-3 and a port (e.g., the first port 143-1) of the radio 142 (FIG. 1B). As an example, the RF input node 304 may comprise, or be coupled to, the first port 145-1 of the antenna 100 (FIG. 1B).

According to some embodiments, the three paths 311-1 through 311-3 may have respective gaps 325-1 through 325-3 that separate the first portion P1 from the second portion P2 in a direction Z. In some embodiments, a first current I1 may flow through the first portion Pl of any of the three paths 311-1 through 311-3, a fifth current 15 may flow through the second portion P2 of any of the three paths 311-1 through 311-3, and a second current 12 may flow in the array-selection portion 202 (e.g., through one or more of the three array-selection paths 312-1 through 312-3). Moreover, third and fourth currents 13, 14 may be separated from each other by gaps 355 in stubs 306 of the array-selection portion 202.

The three array-selection paths 312-1 through 312-3 may be selectively coupled between the impedance-matching portion 201 and arrays 120 of radiating elements RE (FIG. 1A). For example, the three paths 312-1 through 312-3 may be coupled to three arrays 120-1 through 120-3 (FIG. 1A), respectively, via three RF output nodes 305-1 through 305-3, respectively, of the array-selection portion 202. Moreover, the array-selection portion 202 may comprise three stubs 306-1 through 306-3 that extend from/adjacent the three paths 312-1 through 312-3, respectively, and are coupled to electrical ground GND (FIG. 2A).

FIG. 3B is a front view of the switching elements 335, 365 that are omitted from view in FIG. 3A. As shown in FIG. 3B, the feed network 150 may be implemented with the PCB 303, which may be a stationary PCB that comprises the impedance-matching portion 201 (FIG. 3A) and the array-selection portion 202 (FIG. 3A) of the feed network 150. The switching elements 335, 365 may be implemented in one or more movable PCBs that are mounted over the PCB 303. Each of the paths 311 of the impedance-matching portion 201 and each of the paths 312 of the array-selection portion 202 may be implemented by a conductive trace on the PCB 303. Conductive traces described herein may be, for example, copper (or other metal) traces.

In some embodiments, the paths 311 may comprise three impedance-matching paths 311-1 through 311-3 that may be selectively capacitively coupled to three switching elements 335-1 through 335-3, respectively. For example, the impedance-matching paths 311-1 through 311-3 may be selectively coupled between the arrays 120 and the RF input node 304 of the RF feed network 150 by selective capacitive coupling between the switching elements 335-1 through 335-3 and the impedance-matching paths 311-1 through 311-3, respectively. Each switching element 335 may include a conductive trace 331 that is on a respective movable (e.g., wiper-type) PCB 332. Each trace 331 is thus movable based on movement of the PCB 332 that the trace 331 is on. The switching elements 335-1 through 335-3 may be selectively capacitively coupled to first and second portions P1, P2 of the three paths 311-1 through 311-3, respectively, and thereby may selectively couple the first and second portions P1, P2 to each other. In particular, one of the three switching elements 335-1 through 335-3 (e.g., the respective trace 331 thereof) may select its corresponding one of the three paths 311-1 through 311-3 by coupling the first and second portions P1, P2 thereof to each other, while the remaining two of the three switching elements 335-1 through 335-3 do not select their corresponding paths 311 (i.e., do not couple the first and second portions P1, P2 thereof to each other).

As an example, FIG. 3B shows that the first switching element 335-1 does not completely bridge the first gap 325-1 between the first and second portions P1, P2 of the first path 311-1. Rather, the first switching element 335-1 overlaps, in a direction Y, the second portion P2 but not the first portion P1, and thus does not couple the first and second portions P1, P2 to each other. Also, the third switching element 335-3 does not completely bridge the third gap 325-3 between the first and second portions P1, P2 of the third path 311-3. Instead, the third switching element 335-3 overlaps, in the direction Y, the first portion P1 but not the second portion P2. The second switching element 335-2, however, overlaps, in the direction Y, the first and second portions P1, P2 of the second path 311-2, and thus completely bridges the second gap 325-2 (FIG. 3A) and couples the first and second portions P1, P2 to each other. Moreover, the second switch 325-2 may be moved in the direction Z so that it no longer completely bridges the second gap 325-2 but instead overlaps, in the direction Y, only the first portion P1 or only the second portion P2, and the first switching element 335-1 may be moved in the direction Z to completely bridge the first gap 325-1 or the third switching element 335-3 may be moved in the direction Z to completely bridge the third gap 325-3. The directions Y and Z may be perpendicular to each other and to a direction X.

In some embodiments, the paths 312 may comprise three array-selection paths 312-1 through 312-3 that may be selectively coupled between the impedance-matching portion 201 of the PCB 303 and arrays 120 of radiating elements RE (FIG. 1A) by movement of three switching elements 365-1 through 365-3. For example, the three paths 312-1 through 312-3 may be coupled to three arrays 120-1 through 120-3 (FIG. 1A), respectively, via three RF output nodes 305-1 through 305-3, respectively, of the PCB 303. Moreover, the array-selection portion 202 of the PCB 303 may comprise three stubs 306-1 through 306-3 that extend from/adjacent the three paths 312-1 through 312-3, respectively, and are coupled to electrical ground GND (FIG. 2A) and to the three switching elements 365-1 through 365-3, respectively. As an example, each stub 306 may protrude from (and thus be coupled to) a respective path 312 and may be switchably coupled to ground GND by selective capacitive coupling with a respective switching element 365.

Each switching element 365 may include a conductive trace 361 that is on a respective movable (e.g., wiper-type) PCB 362, and thus is also movable (based on movement of the PCB 362). According to some embodiments, the three switching elements 365-1 through 365-3 may be configured to select the three paths 312-1 through 312-3, respectively, based on whether the three switching elements 365-1 through 365-3 (e.g., the respective traces 361 thereof) completely bridge respective gaps 355 between spaced-apart first and second portions of the three stubs 306-1 through 306-3, respectively. As an example, FIG. 3B shows that the first switching element 365-1 overlaps (and thus is capacitively coupled to), in the direction Y, spaced-apart first and second portions of the first stub 306-1, thereby completely bridging the first gap 355-1 (FIG. 3A). Also, the second switching element 365-2 overlaps (and thus is capacitively coupled to), in the direction Y, spaced-apart first and second portions of the second stub 306-2, thereby completely bridging the second gap 355-2 (FIG. 3A). The third switching element 365-3, on the other hand, does not completely bridge the third gap 355-3 between first and second portions of the third stub 306-3. Moreover, the third switching element 365-3 may be moved in the direction Z so that it completely bridges the third gap 355-3, the first switching element 365-1 may be moved in the direction Z so that it is capacitively coupled to only one of the first and second portions of the first stub 306-1, and/or the third switching element 365-3 may be moved in the direction Z so that it is capacitively coupled to only one of the first and second portions of the third stub 306-3.

Accordingly, the three switching elements 365-1 through 365-3 may be selectively capacitively coupled to the spaced-apart portions of the three stubs 306-1 through 306-3, respectively. FIG. 3B shows an example in which the first and second arrays 120-1 and 120-2 are selected (and the third array 120-3 is not selected) by using the first and second switching elements 365-1, 365-2 to completely bridge the first and second gaps 355-1, 355-2 in the first and second stubs 306-1, 306-2, respectively, while the third switching element 365-3 does not completely bridge the third gap 355-3. The third stub 306-3 thus acts to reflect RF energy from proceeding through the third path 312-3 and redirects it to the first and second paths 312-1, 312-2. As a result, the feed network 150 directs RF energy from an RF input port 304 of the feed network 150 to two RF output ports 305-1, 305-2 of the feed network 150. The input port 304 may be, or may be coupled to, the first port 145-1 (FIG. 1B) of the antenna 100 (FIG. 1B). The two output ports 305-1, 305-2 are coupled to the first and second arrays 120-1, 120-2 (FIG. 2A), respectively.

FIG. 3B thus shows a configuration in which RF energy is provided to two sectors (and not all three sectors) of the antenna 100 (FIG. 1B). By moving the switching elements 365, however, any permutation of the three arrays 120-1 through 120-3 may be selected. For example, RF energy may be directed to all three arrays 120-1 through 120-3 when the three switching elements 365-1 through 365-3 completely bridge the three gaps 355-1 through 355-3, respectively, thereby providing an omnidirectional configuration/state of the feed network 150. As another example, RF energy may be directed to only one of the three arrays 120-1 through 120-3 when only one of the three switching elements 365-1 through 365-3 completely bridges a respective gap 355, thereby providing a single-sector configuration/state of the feed network 150.

As used herein, the term “completely bridge” refers to a continuous extension in the direction Z across an entire length of a gap 325 (or a gap 355) in the direction Z. The term “completely bridge” thus does not require a particular width in the direction X. Accordingly, a conductive trace 331 that completely bridges a gap 325 (or a conductive trace 361 that completely bridges a gap 355) may be wider, narrower, or the same width in the direction X as one or more portions of a corresponding path 311 (or path 312) having the gap 325 (or gap 355) therein.

For simplicity of illustration, connections in FIG. 3B are shown with respect to the single input port 304. Analogous connections, however, may be provided between three additional input ports 304 (which may be, or may be coupled to, the second through fourth ports 145-2 through 145-4 of the antenna 100) and three sets of three additional output ports 305 that are coupled to the arrays 120. The feed network 150 may thus include four instances of the circuitry shown in FIG. 3B coupled between the four ports 143-1 through 143-4 (FIG. 1B), respectively, of the radio 142 (FIG. 1B) and the six arrays 120-1 through 120-6. Accordingly, each port 143 of the radio 142 may be coupled to a respective input port 304 of the feed network 150, the first through third arrays 120-1 through 120-3 may be coupled to two sets of three output ports 305, and fourth through sixth arrays 120-4 through 120-6 may be coupled to another two sets of three output ports 305. Each set of three output ports 305 is coupled to a respective input port 304 via three paths 311 of the impedance-matching portion 201 (FIG. 3A) of the feed network 150 and three paths 312 of the array-selection portion 202 (FIG. 3A) of the feed network 150.

Though the movable traces 331 may, in some embodiments, be on only respective rear surfaces (and thus not respective front surfaces) of the movable PCBs 332, the switching elements 335 are shown semi-transparently in FIG. 3B for simplicity of illustrating positions of the traces 331. Similarly, though the movable traces 361 may, in some embodiments, be on only respective rear surfaces (and thus not respective front surfaces) of the movable PCBs 362, the switching elements 365 are shown semi-transparently in FIG. 3B for simplicity of illustrating positions of the traces 361.

In some embodiments, each first portion P1 of the three paths 311-1 through 311-3 may have the same impedance (e.g., 50 ohms), and each second portion P2 of the three paths 311-1 through 311-3 may have a different impedance. For example, the second portion P2 of the first path 311-1 may have an impedance that is higher than an impedance of the second portion P2 of the second path 311-2 and lower than an impedance of the second portion P2 of the third path 311-3. According to some embodiments, an impedance transformation (e.g., an impedance stepdown) may occur from the first portion P1 of the first path 311-1 to the second portion P2 of the first path 311-1, and from the first portion P1 of the second path 311-2 to the second portion P2 of the second path 311-2.

In some embodiments, the switching elements 335 and/or the switching elements 365 may be moved under the control of the control circuit 204 (FIG. 2A). For example, the switching elements 335 may move linearly in the direction Z to select exactly one of the three impedance-matching paths 311-1 through 311-3, and the switching elements 365 may move linearly in the direction Z to select one or more of the three array-selection paths 312-1 through 312-3.

FIG. 3C is an enlarged view of a first switching element 335-1 of the switching elements 335 of FIG. 3B, according to some embodiments of the present invention. As shown in FIG. 3C, the first switching element 335-1 may comprise a first movable PCB 332-1 and a first conductive trace 331-1 that is on the first movable PCB 332-1. For simplicity of illustration, only the first switching element 335-1 is shown in FIG. 3C. In some embodiments, however, the second and third switching elements 335-2, 335-3 may have respective movable PCBs 332 and respective conductive traces 331 thereon, analogously to what is shown in FIG. 3C with respect to the first switch 331-1. Because the three switching elements 335-1 through 335-3 are implemented with respective movable PCBs 332, the respective traces 331 thereof may be moved linearly in the direction Z independently of each other.

For simplicity of illustration, the movable first PCB 332-1 is shown in FIG. 3C as having a narrow rectangular shape similar to that of the first trace 331-1 thereon. In some embodiments, however, the movable first PCB 332-1 may have a wider rectangular shape or may have a non-rectangular shape, such as a circular or semicircular shape.

FIG. 3D is an enlarged view of switching elements 335 of FIG. 3B that comprise respective conductive traces 331 that share a movable (e.g., wiper-type) PCB 333, according to other embodiments of the present invention. Accordingly, a single DC motor and associated mechanical linkage may simultaneously move all of the traces 331.

As shown in FIG. 3D, three switching elements 335-1 through 335-3 may comprise three conductive traces 331-1 through 331-3 that all share the same movable PCB 333. For example, the three traces 331-1 through 331-3 may be spaced apart from each other on the movable PCB 333 in direction X, and may be staggered along (e.g., may be at different positions in) the direction Z. This staggering may facilitate selection of only one of the three impedance-matching paths 311-1 through 311-3 (FIG. 3A) at a time. In contrast with the three independently-movable PCBs 332 that are shown in FIG. 3B, linear movement of the movable shared PCB 333 in the direction Z simultaneously moves all three traces 331-1 through 331-3 in the direction Z. In other embodiments, the gaps on stationary PCB 303 may be staggered and the three traces 331-1 through 331-3 may be aligned along the direction Z (or may be less staggered). Accordingly, though the independently-movable PCBs 332 are shown in FIG. 3B for simplicity of illustration, the movable shared PCB 333 may be implemented with (e.g., in front of) the stationary PCB 303 that is shown in FIG. 3B instead of using the independently-movable PCBs 332 together with the PCB 303, according to some embodiments.

FIG. 3E is a schematic rear view of a movable (e.g., wiper-type) PCB 343 that is configured to move rotationally, according to further embodiments of the present invention. As shown in FIG. 3E, a conductive trace 334 is on the PCB 343. In some embodiments, the PCB 343 (and thus the trace 334 thereon) may rotate clockwise or counter-clockwise in the X-Z plane. Accordingly, though the linearly-movable PCBs 332 are shown in FIG. 3B for simplicity of illustration, the rotationally-movable PCB 343 may be implemented with (e.g., in front of) the stationary PCB 303 that is shown in FIG. 3B instead of using the independently-movable PCBs 332 together with the PCB 303, according to some embodiments.

The three impedance-matching paths 311-1 through 311-3 (FIG. 3B) that are on the PCB 303 may be selected by rotation of one or more traces 334. For example, the trace 334 that is shown in FIG. 3E may be configured to rotate with the PCB 343 that it is on to select any one of the impedance-matching paths 311-1 through 311-3, or a plurality of traces 334 may be configured to select respective ones of the paths 311-1 through 311-3 and may share the PCB 343 or may be on respective rotationally-movable PCBs 343. Thus, according to some embodiments, each switching element 335 that is shown in FIG. 3B may be implemented as an independently-rotatable switch having a respective rotatable trace 334 that is configured to selectively capacitively couple to a respective impedance-matching path 311 (FIG. 3A). In other embodiments, a single rotatable switch having one or more rotatable traces 334 may be configured to selectively capacitively couple to any one of the three paths 311. Moreover, though the trace 334 is illustrated in FIG. 3E as extending longitudinally in the direction X, one or more traces 334 on the PCB 343 may, in some embodiments, instead extend longitudinally in the direction Z, or diagonally to the directions X, Z.

FIG. 3F is an example front view of the feed network 150′ of FIG. 2C. As shown in FIG. 3F, a PCB 303′ may comprise an impedance-matching portion comprising a plurality of impedance-matching paths 311′ and an array-selection portion comprising a plurality of array-selection paths 312′. The paths 311′ may be coupled between the paths 312′ and an RF input node 304′ of the PCB 303′. Each of the paths 311′ and each of the paths 312′ may be implemented by a conductive trace on the PCB 303′.

In some embodiments, the paths 311′ may comprise three impedance-matching paths 311-1′ through 311-3′ that may be selectively capacitively coupled to a single switching element 335′. For example, the switching element 335′ may be configured to move in the direction Z so that it overlaps (and thus is capacitively coupled to), in the direction Y, one of the three paths 311-1′ through 311-3′ at a time. Though FIG. 3F shows the switching element 335′ overlapping the second path 311-2′, the switching element 335′ may move to overlap any of the three paths 311-1′ through 311-3′.

The array-selection portion of the PCB 303′ may be similar to that of the PCB 303 shown in FIG. 3B, in that three switching elements 365-1 through 365-3 may be selectively capacitively coupled to three stubs 306-1′ through 306-3′, respectively, where each stub 306′ may be coupled to electrical ground GND (FIG. 2C) and may have spaced-apart first and second portions having a gap 355 therebetween. Shapes of three array-selection paths 312-1′ through 312-3′, however, may vary relative to shapes of the three array-selection paths 312-1 through 312-3 shown in FIG. 3B, in some embodiments. Moreover, the three paths 312-1′ through 312-3′ may be coupled to three arrays 120-1 through 120-3 (FIG. 1A), respectively, via three RF output nodes 305-1′ through 305-3′, respectively, of the array-selection portion of the PCB 303′.

FIG. 3G is an enlarged view of the switching element 335′ of the impedance-matching portion of FIG. 3F. As shown in FIG. 3G, the switching element 335′ may comprise a movable (e.g., wiper-type) PCB 332′ having a conductive trace 331′ thereon. In some embodiments, the trace 331′ may be L-shaped, which may facilitate movement of the trace 331′ in the direction Z between different ones of the three paths 311-1′ through 311-3′. For simplicity of illustration, the movable PCB 332′, like the trace 331′ thereon, is shown in FIG. 3F as being L-shaped. In some embodiments, however, the movable PCB 332′ may have a shape different from that of the trace 331′ thereon. For example, the movable PCB 332′ may have a rectangular shape or a circular or semicircular shape.

FIG. 3H is a schematic block diagram of a movable (e.g., wiper-type) PCB 353 that is configured to select any of seven states of the array-selection portion 202 (FIG. 2A) of the feed network 150 of FIG. 1B, according to other embodiments of the present invention. As shown in FIG. 3H, the PCB 353 may have a plurality of conductive traces 361 thereon. For example, the traces 361 may comprise four traces 361-1 through 361-4 that share the PCB 353. Accordingly, a single mechanical linkage may simultaneously move all of the traces 361 in the direction X.

FIG. 3I is a schematic block diagram showing seven different positions of the movable PCB 353 of FIG. 3H relative to the stationary PCB 303, and thus seven different array-selection states, respectively, of the antenna 100. For simplicity of illustration, the three array-selection paths 312-1 through 312-3 that are on the stationary PCB 303 are omitted from view in FIG. 3I. Moreover, the traces 361 of the PCB 353 are shown at different positions in the direction Z in FIG. 3I for simplicity of illustrating the seven different states. In some embodiments, the PCB 353 (and thus the traces 361) may move linearly in the direction X without moving in the direction Z.

According to some embodiments, the fourth trace 361-4 may be spaced apart from the third trace 361-3 in the direction X by a longer distance than any other pair of adjacent traces 361. This increased distance may facilitate overlap, in the direction Y, between the fourth trace 361-4 and a stub 306 corresponding to any of the three array-selection paths 312-1 through 312-3 that are on the stationary PCB 303 shown in FIG. 3B, while the first through third traces 361-1 through 361-3 do not overlap any stub 306 of the remaining two of the three array-selection paths 312-1 through 312-3.

The four traces 361-1 through 361-4 may be used to select any of seven array-selection states of the antenna 100, including (i) a first state in which the antenna 100 uses (e.g., transmits and/or receives RF signals via) only the first array 120-1 (FIG. 1A) and not the second or third arrays 120-2, 120-3 (FIG. 1A), (ii) a second state in which the antenna 100 uses only the second array 120-2 and not the first or third arrays 120-1, 120-3, (iii) a third state in which the antenna 100 uses only the third array 120-3 and not the first or second arrays 120-1, 120-2, (iv) a fourth state in which the antenna 100 uses the first and second arrays 120-1, 120-2 and not the third array 120-3, (v) a fifth state in which the antenna 100 uses the first and third arrays 120-1, 120-3 and not the second array 120-2, (vi) a sixth state in which the antenna 100 uses the second and third arrays 120-2, 120-3 and not the first array 120-1, and (vii) a seventh state in which the antenna 100 uses all three arrays 120-1 through 120-3. Accordingly, though independently-movable PCBs 365 are shown in FIG. 3B for simplicity of illustration, the movable shared PCB 353 may be implemented with (e.g., in front of) the stationary PCB 303 that is shown in FIG. 3B instead of using the independently-movable PCBs 365 together with the PCB 303, according to some embodiments.

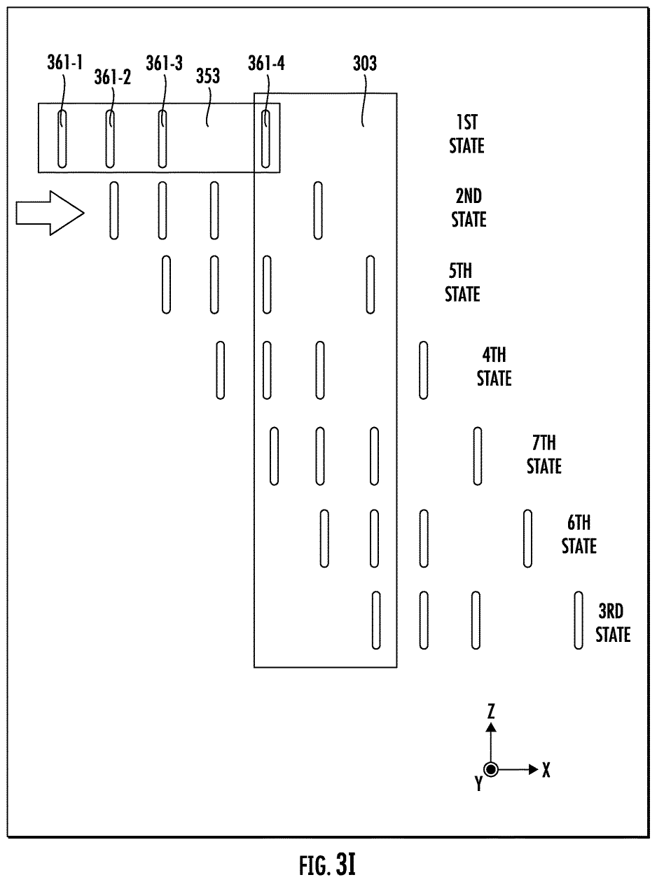

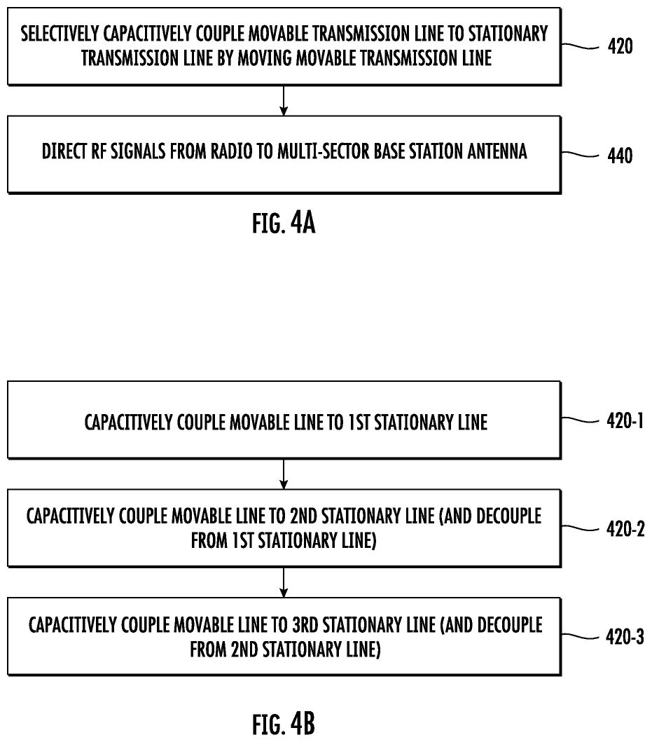

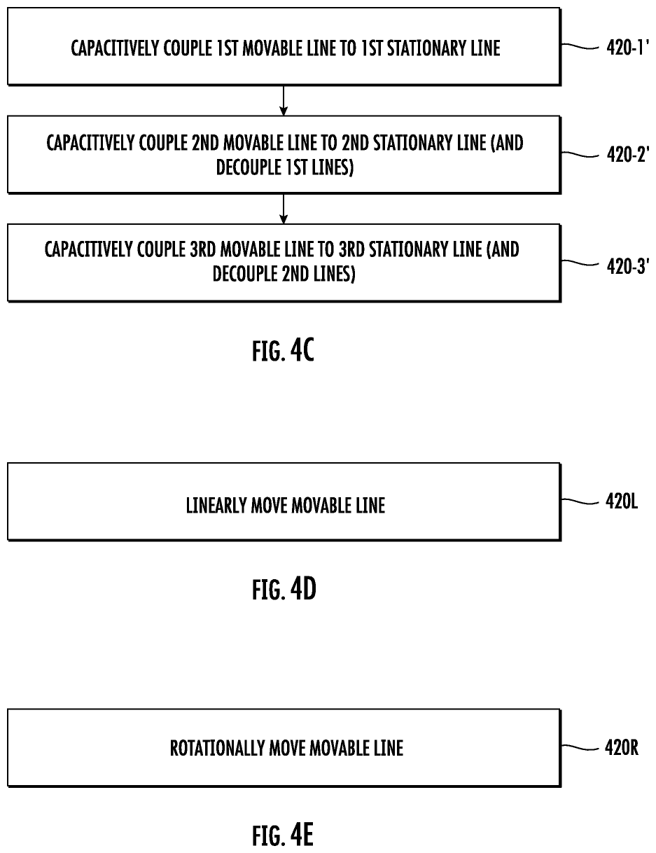

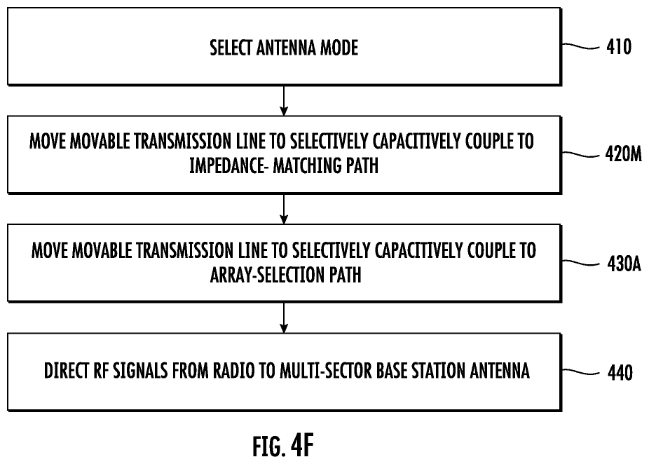

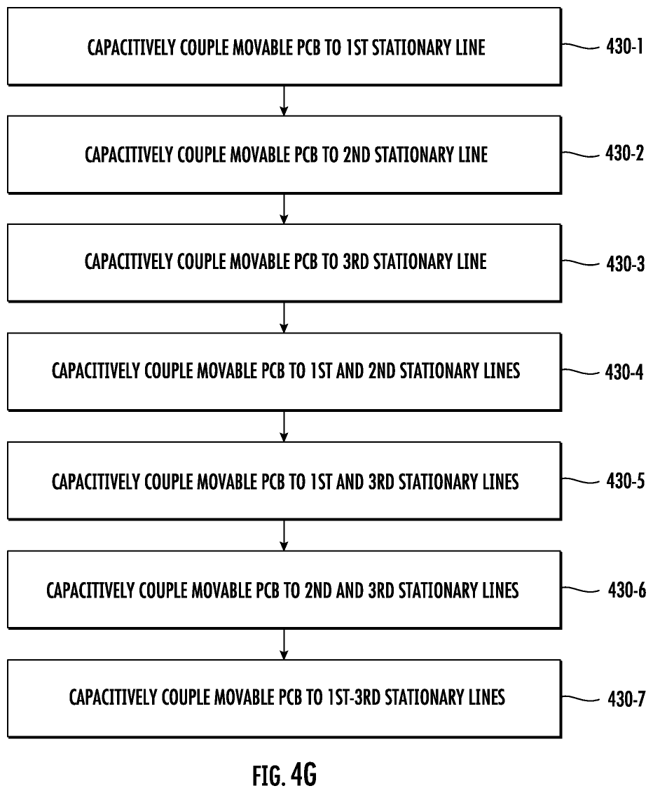

FIGS. 4A-4G are flowcharts illustrating operations of switching between the RF paths 211/212 shown in FIGS. 2A-2C. As shown in FIG. 4A, the operations include selectively capacitively coupling (Block 420) a movable RF transmission line to a stationary RF transmission line by moving the movable transmission line. For example, referring to FIG. 3B, the stationary transmission line may comprise an impedance-matching path 311 on a stationary PCB 303 and the movable transmission line may comprise a conductive trace 331 on a linearly-movable PCB 332. As another example, the stationary transmission line may comprise a stub 306 that extends from an array-selection path 312 on the PCB 303 and the movable transmission line may comprise a conductive trace 361 on a linearly-movable PCB 362.

The stationary transmission line is a first of a plurality of stationary transmission lines of an RF feed network 150 (FIG. 3A) that are coupled between an RF input node 304 (FIG. 3A) of the RF feed network 150 and a plurality of arrays 120 of a multi-sector base station antenna 100 (FIG. 1A). Moreover, the operations include directing (Block 440) RF signals from a radio 142 (FIG. 1B) to the antenna 100. For example, the RF signals may be directed through the movable transmission line and the first of the stationary transmission lines to one or more of the arrays 120.

FIG. 4B illustrates example details of Block 420 of FIG. 4A. As shown in FIG. 4B, the operation(s) of Block 420 may include capacitively coupling (Block 420-1) the movable transmission line to the first of the stationary transmission lines, and subsequently capacitively decoupling the movable transmission line from the first of the stationary transmission lines (and/or decoupling the first of the stationary transmission lines from between the arrays 120 and the RF input node 304 by moving the movable transmission line) and capacitively coupling (Block 420-2) the movable transmission line to a second of the stationary transmission lines (and/or coupling the second of the stationary transmission lines between the arrays 120 and the RF input node 304 by moving the movable transmission line). Moreover, the operation(s) of Block 420 may include capacitively decoupling the movable transmission line from the second of the stationary transmission lines (and/or decoupling the second of the stationary transmission lines from between the arrays 120 and the RF input node 304 by moving the movable transmission line) and capacitively coupling (Block 420-3) the movable transmission line to a third of the stationary transmission lines (and/or coupling the third of the stationary transmission lines between the arrays 120 and the RF input node 304 by moving the movable transmission line). Accordingly, the same movable transmission line may be selectively capacitively coupled to any of the first through third of the stationary transmission lines. For example, referring to FIG. 3F, a single conductive trace 331′ may be moved linearly in the direction Z to be selectively capacitively coupled to any of the impedance-matching paths 311-1′ through 311-3′.

In some embodiments, an operation of selectively capacitively coupling a movable transmission line may comprise moving the movable transmission line away from one stationary transmission line (any thereby capacitively decoupling the two lines) and toward another stationary transmission line until the movable transmission line and the other stationary transmission line are capacitively coupled to each other. For example, the conductive trace 331′ that is shown in FIG. 3F may be moved linearly in the direction Z away from the second impedance-matching path 311-2′ and toward either of the first or third impedance-matching paths 311-1′, 311-3′.

FIG. 4C is a modification of FIG. 4B in which a plurality of movable transmission lines are used rather than a single movable transmission line. As shown in FIG. 4C, the operation(s) of Block 420 may include capacitively coupling (Block 420-1′) a first of the movable transmission lines to the first of the stationary transmission lines, and subsequently capacitively decoupling the first of the movable transmission lines from the first of the stationary transmission lines (and/or decoupling the first of the stationary transmission lines from between the arrays 120 and the RF input node 304 by moving the first of the movable transmission lines) and capacitively coupling (Block 420-2′) a second of the movable transmission lines to a second of the stationary transmission lines (and/or coupling the second of the stationary transmission lines between the arrays 120 and the RF input node 304 by moving the second of the movable transmission lines). Moreover, the operation(s) of Block 420 may include capacitively decoupling the second of the movable transmission lines from the second of the stationary transmission lines (and/or decoupling the second of the stationary transmission lines from between the arrays 120 and the RF input node 304 by moving the second of the movable transmission lines) and capacitively coupling (Block 420-3′) a third of the movable transmission lines to a third of the stationary transmission lines (and/or coupling the third of the stationary transmission lines between the arrays 120 and the RF input node 304 by moving the third of the movable transmission lines). Accordingly, the first through third of the movable transmission lines may be selectively capacitively coupled to the first through third of the stationary transmission lines, respectively. For example, referring to FIG. 3B, first through third switching elements 335-1 through 335-3 may have three conductive traces 331, respectively, thereon that may be independently moved linearly in the direction Z to be selectively capacitively coupled to the impedance-matching paths 311-1 through 311-3, respectively (e.g., by selectively completely bridging the gaps 325-1 through 325-3, respectively (FIG. 3A)).

FIG. 4D is a modification of Block 420 of FIG. 4A that specifies that moving the movable transmission line comprises linearly moving (Block 420L) the movable transmission line. For example, one of the conductive traces 331 (or one of the conductive traces 361) shown in FIG. 3B may move linearly in the direction Z to completely bridge a gap 325 (or a gap 355) and to overlap (and thereby capacitively couple to), in the direction Y, portions of a path 311 (or a stub 306) that are spaced apart from each other by the gap 325 (or the gap 355).

FIG. 4E is a modification of Block 420 of FIG. 4A that specifies that moving the movable transmission line comprises rotationally moving (Block 420R) the movable transmission line. For example, the conductive trace 334 shown in FIG. 3E may move rotationally in the X-Z plane to completely bridge a gap 325 (or a gap 355) and to overlap (and thereby capacitively couple to), in the direction Y, portions of a path 311 (or a stub 306) that are spaced apart from each other by the gap 325 (or the gap 355).

FIG. 4F shows a modification of Block 420 of FIG. 4A that specifies that moving the movable transmission line comprises moving (Block 420M) the movable transmission line to selectively capacitively couple the movable transmission line to an impedance-matching path 311 (FIG. 3B). For example, a conductive trace 331 shown in FIG. 3B may move linearly in the direction Z to completely bridge a gap 325 and to overlap (and thereby capacitively couple to), in the direction Y, first and second portions P1, P2 of the path 311 that are spaced apart from each other by the gap 325. Moreover, operations of the antenna 100 may include moving (Block 430A) another movable transmission line to selectively capacitively couple the other movable transmission line to a stub 306 of an array-selection path 312 (FIG. 3B). As an example, a conductive trace 361 shown in FIG. 3B may move linearly in the direction Z to completely bridge a gap 355 and to overlap (and thereby capacitively couple to), in the direction Y, first and second portions of the stub 306 that are spaced apart from each other by the gap 355.

In some embodiments, as illustrated in FIG. 4F, moving (Block 420M) the movable transmission line and/or moving (Block 430A) the other movable transmission line may be performed in response to selecting (Block 410) one of a single-sector mode, a two-sector mode, or an omnidirectional (e.g., three-sector) mode of the antenna 100. RF signals may be directed (Block 440) from the radio 142 to a single sector, two sectors, or three sectors of the antenna 100 (via the feed network 150), depending on whether the single-sector mode, the two-sector mode, or the omnidirectional mode is selected. Accordingly, RF signals may be selectively directed to any permutation of the sectors.

FIG. 4G shows a modification of Block 430A of FIG. 4F that corresponds to FIG. 3H, which illustrates four conductive traces 361-1 through 361-4 that share a movable PCB 353 and are configured to selectively capacitively couple the PCB 353 to any permutation of the three stubs 306-1 through 306-3 of the array-selection paths 312-1 through 312-3. As a result, any permutation of the array-selection paths 312-1 through 312-3 may be selected. For example, Blocks 430-1 through 430-3 of FIG. 4G show that any one of the three array-selection paths 312-1 through 312-3 may be independently selected in a single-sector mode of the antenna 100. Also, Blocks 430-4 through 430-6 of FIG. 4G show that any two of the three array-selection paths 312-1 through 312-3 may be selected in a two-sector mode of the antenna 100. Moreover, Block 430-7 shows that all three of the array-selection paths 312-1 through 312-3 may be selected in an omnidirectional mode of the antenna 100. The seven different states of the array-selection portion 202 may be selectively chosen by moving the PCB 353 in the direction X.

Referring to Blocks 430-1 through 430-3, FIG. 4G specifies that selectively coupling to a stub 306 of an array-selection path 312 comprises capacitively coupling (Block 430-1) the PCB 353 to a first stationary transmission line of the array-selection portion 202 (FIG. 3A) of the RF feed network 150. For example, the fourth conductive trace 361-4 may completely bridge a gap 355 of the first stub 306-1, while none of the remaining three of the four conductive traces 361-1 through 361-4 completely bridges any gap 355 of the second and third stubs 306-2, 306-3.

FIG. 4G also illustrates capacitively coupling (Block 430-2) the PCB 353 to a second stationary transmission line of the array-selection portion 202. For example, the fourth conductive trace 361-4 may completely bridge a gap 355 of the second stub 306-2, while none of the remaining three of the four conductive traces 361-1 through 361-4 completely bridges any gap 355 of the first and third stubs 306-1, 306-3. Moreover, the PCB 353 may be capacitively coupled (Block 430-3) to a third stationary transmission line of the array-selection portion 202. As an example, the first conductive trace 361-1 may completely bridge a gap 355 of the third stub 306-3, while none of the remaining three of the four conductive traces 361-1 through 361-4 completely bridges any gap 355 of the first and second stubs 306-1, 306-2.

Referring to Blocks 430-4 through 430-6 of FIG. 4G, the PCB 353 may be simultaneously capacitively coupled (Block 430-4) to the first and second stationary transmission lines. As an example, the second and third conductive traces 361-2, 361-3 may completely bridge the gaps 355-1, 355-2 of the first and second stubs 306-1, 306-2, while none of the remaining two of the four conductive traces 361-1 through 361-4 completely bridges the gap 355-3 of the third stub 306-3. Also, the PCB 353 may be simultaneously capacitively coupled (Block 430-5) to the first and third stationary transmission lines. As an example, third and fourth conductive traces 361-3, 361-4 may completely bridge the gaps 355-1, 355-3 of the first and third stubs 306-1, 306-3, while none of the remaining two of the four conductive traces 361-1 through 361-4 completely bridges the gap 355-2 of the second stub 306-2. Moreover, the PCB 353 may be simultaneously capacitively coupled (Block 430-6) to the second and third stationary transmission lines. As an example, second and third conductive traces 361-2, 361-3 may completely bridge the gaps 355-2, 355-3 of the second and third stubs 306-2, 306-3, while none of the remaining two of the four conductive traces 361-1 through 361-4 completely bridges the gap 355-1 of the first stub 306-1.

Referring to Block 430-7 of FIG. 4G, the PCB 353 may be simultaneously capacitively coupled to the first, second, and third stationary transmission lines. As an example, the first through third conductive traces 361-1 through 361-3 may completely bridge the gaps 355-1 through 355-3 of the first through third stubs 306-1 through 306-3, respectively.

RF feed networks 150, 150′ (FIGS. 2A and 2C) according to embodiments of the present invention may provide a number of advantages. These advantages include reducing PIM distortion by using a switching element (e.g., a switching element 335 or a switching element 365, as shown in FIG. 3B) comprising a movable RF transmission line that is selectively capacitively coupled to a stationary RF transmission line, rather than using a switching element that physically contacts the stationary transmission line. For example, the movable transmission line may be implemented by using a conductive trace on a movable PCB that moves over the stationary transmission line, and may therefore provide a low-cost solution that is relatively easy to achieve. In addition, all of the RF energy output by the radio is coupled to the selected linear array(s), thereby eliminating the power-division losses present in conventional switched antennas. In some embodiments, the movable PCB may be linearly movable, which may facilitate use of a small movable PCB in a narrow space. Moreover, the movable transmission line may facilitate (e.g., may avoid negatively impacting) high-power RF performance of a base station antenna 100 (FIG. 1A) that includes the feed network 150 (or the feed network 150′).

The present invention has been described above with reference to the accompanying drawings. The present invention is not limited to the illustrated embodiments. Rather, these embodiments are intended to fully and completely disclose the present invention to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” “coupled,” and the like can mean either direct or indirect attachment or coupling between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A base station antenna, comprising:
a plurality of arrays of radiating elements; and
a radio frequency (RF) feed network that has a plurality of stationary RF transmission lines that are selectively coupled between the arrays and an input of the RF feed network by one or more movable RF transmission lines.

2. The base station antenna of claim 1,
wherein the one or more movable RF transmission lines comprise a plurality of metal traces that are on a plurality of independently-movable printed circuit boards (PCBs), respectively, and
wherein the stationary RF transmission lines are selectively coupled between the arrays and the input of the RF feed network by selective capacitive coupling between the stationary RF transmission lines and the independently-movable PCBs, respectively.

3. The base station antenna of claim 2, wherein the independently-movable PCBs are configured to move linearly.

4. (canceled)

5. The base station antenna of claim 1, wherein the one or more movable RF transmission lines comprise a plurality of metal traces that share a movable printed circuit board (PCB) and selectively couple the stationary RF transmission lines, respectively, between the arrays and the input of the RF feed network.

6. The base station antenna of claim 5, wherein a first of the metal traces of the movable PCB is configured to couple a first of the stationary RF transmission lines between the arrays and the input of the RF feed network, while a second and a third of the stationary RF transmission lines are not coupled between the arrays and the input of the RF feed network.

7. The base station antenna of claim 6, wherein the movable PCB is further configured to move to decouple the first of the stationary RF transmission lines from between the arrays and the input of the RF feed network and to couple, via a second of the metal traces of the movable PCB, the second of the stationary RF transmission lines between the arrays and the input of the RF feed network.

8. The base station antenna of claim 7, wherein the movable PCB is further configured to move to decouple the second of the stationary RF transmission lines from between the arrays and the input of the RF feed network and to couple, via a third of the metal traces of the movable PCB, the third of the stationary RF transmission lines between the arrays and the input of the RF feed network.

9. The base station antenna of claim 5, wherein the movable PCB is configured to move linearly.

10. (canceled)

11. The base station antenna of claim 1, wherein the one or more movable RF transmission lines comprise a single metal trace that is on a movable printed circuit board (PCB) and is selectively capacitively coupled to any of the stationary RF transmission lines.

12. The base station antenna of claim 11, wherein the movable PCB is configured to capacitively couple the single metal trace to a first of the stationary RF transmission lines.

13. The base station antenna of claim 12, wherein the movable PCB is further configured to move to capacitively decouple the single metal trace from the first of the stationary RF transmission lines and to capacitively couple the single metal trace to a second of the stationary RF transmission lines.

14. The base station antenna of claim 13, wherein the movable PCB is further configured to move to capacitively decouple the single metal trace from the second of the stationary RF transmission lines and to capacitively couple the single metal trace to a third of the stationary RF transmission lines.

15. The base station antenna of claim 11, wherein the movable PCB is configured to move linearly.

16. The base station antenna of claim 11, wherein the movable PCB is configured to move rotationally.

17. The base station antenna of claim 1, further comprising a triangular reflector that has a plurality of faces that face in different directions, respectively,
wherein the arrays of radiating elements are on the respective faces of the reflector, and
wherein the stationary RF transmission lines comprise three impedance-matching paths.

18. The base station antenna of claim 1,
wherein the stationary RF transmission lines comprise respective impedance-matching paths,
wherein the RF feed network further comprises:
a plurality of stationary array-selection paths that are coupled between the arrays and the impedance-matching paths; and
a plurality of movable printed circuit boards (PCBs) having respective metal traces thereon that are configured to be selectively capacitively coupled to respective stubs that are coupled to the stationary array-selection paths, respectively.

19. The base station antenna of claim 1,
wherein the stationary RF transmission lines comprise respective impedance-matching paths, and
wherein the RF feed network further comprises:
a plurality of stationary array-selection paths that are coupled between the arrays and the impedance-matching paths; and
a movable printed circuit board (PCB) comprising a plurality of metal traces that share the movable PCB and are configured to be selectively capacitively coupled to any of a plurality of stubs that are coupled to the stationary array-selection paths, respectively.

20. The base station antenna of claim 1,
wherein the stationary RF transmission lines comprise respective impedance-matching paths that each comprise a first portion and a second portion that is spaced apart from the first portion, and
wherein each of the one or more movable RF transmission lines is configured to be capacitively coupled to the first and second portions of a respective one of the impedance-matching paths.

21. A method of operating a base station antenna, the method comprising selectively capacitively coupling a first of a plurality of stationary radio frequency (RF) transmission lines of an RF feed network of the base station antenna to a movable RF transmission line of the RF feed network by moving the movable RF transmission line, wherein the stationary RF transmission lines are coupled between an input of the RF feed network and a plurality of arrays of radiating elements of the base station antenna.

22.-28. (canceled)

29. A base station antenna, comprising:
a plurality of arrays of radiating elements; and
a radio frequency (RF) feed network that has a plurality of stationary impedance-matching paths that are selectively coupled between the arrays and an input of the RF feed network by a plurality of movable RF transmission lines, respectively.

30.-33. (canceled)
